(19) United States
(12) Patent Application Publication
(10) Pub. No.: US 2026/0330284 A1
(43) Pub. Date: Oct. 22, 2026

(54) BLOCK-SEQUENTIAL APPROXIMATE CIRCUIT EXECUTION AND AN ADAPTIVE EXECUTION BLOCK SELECTION PROCEDURE

(71) Applicant: Haiqu, Inc., San Francisco, CA (US)

(72) Inventors: Mykola Maksymenko, Lviv (UA); Maciej Koch-Janusz, Zurich (CH)

(21) Appl. No.: 18/440,629

(22) Filed: Feb. 13, 2024

(51) Int. Cl. G06N 10/60

(52) U.S. Cl. CPC G06N 10/60

(57) ABSTRACT

A block-sequential approximate circuit execution and a block-sequential approximate circuit execution system and method thereof includes receiving an input quantum circuit. The method further includes dividing the input quantum circuit into a set of blocks, the set of blocks including an initial block and one or more additional blocks. The method further includes executing, by a Quantum Processing Unit, the set of blocks, the initial block is executed on a first state and a block of the one or more additional blocks is executed in a second state. The method further includes training, by the Quantum Processing Unit, a parametrized quantum circuit such that the parametrized quantum circuit is operable to reproduce the second state. The method further includes outputting, by the Quantum Processing Unit, an expected output of the input quantum circuit.

### TECHNICAL FIELD

The disclosure relates to quantum computing. More specifically, this disclosure relates to quantum circuit compilation and execution with the focus on efficient execution of quantum circuits by effectively reducing their depth during the execution on the quantum computer.

### BACKGROUND

Quantum computing represents a significant leap from traditional computing, harnessing aspects of quantum mechanics to process information using quantum bit called “qubits” that are able to represent states which are arbitrary linear combinations of the values “0” and “1”. Solving computational problems using a quantum processor requires translating them into the language of quantum mechanics. In digital quantum processing architectures this involves the construction of a quantum circuit representing the quantum algorithm. This is performed by using a sequence of quantum gates similar to logic gates in traditional computing. The sequence of quantum gates manipulate the qubits by changing the state of the qubits. Building and operating the quantum processor to accurately represent and manipulate the qubits presents challenges.

The concept of quantum volume provides a measure of performance and capabilities of a Quantum Processing Unit (QPU). The quantum volume may be used to benchmark the QPU's capacity to handle complex algorithms. Quantum volume considers both hardware factors such as gate fidelity, measurement error, connectivity, and decoherence time of the qubits, as well as the software components of the system, such as compiling, routing and error mitigation routines. The quantum volume is a single scalar value that represents the quality and performance of the QPU. Quantum operations are performed using the sequence of quantum gates, which may be influenced by imperfection of hardware leading to errors in the results of calculation. A QPU with a greater quantum volume indicates that the QPU is able to execute, with sufficient accuracy, wider (in number of qubits) and more complex (in terms of depth, or number of gates) quantum circuits. As such, this QPU can execute more complex sequences of gates with reduced error rates.

However, reliability of resulting measurements of an output of an algorithm decreases as the number of necessary algorithmic steps to be executed on a noisy QPU or simulated noisy QPU is growing. The noisy QPU refers to a quantum processor that operates in a computing environment where various real-world factors such as e.g., thermal noise or electromagnetic fields, disturb states of qubits, which may lead to computational errors. The disturbances are also caused whenever a quantum gate is applied, as their physical realizations intrinsically introduce complex errors, which may entirely spoil the computations for sufficiently large number of quantum gates in a sequence. Thus, a solution as disclosed herein that effectively reduces the number of quantum gates in the quantum circuit being executed on the QPU allows to execute more complex algorithms on current noisy quantum processors.

### SUMMARY

The present disclosure relates to systems and methods that enable efficient execution of quantum circuits by effectively reducing the depth of the quantum algorithms. The present system and method, enables the execution of deep quantum circuits of various types in a block-sequential manner directly on a QPU without requiring intermediate classical simulation. As described herein, the present disclosure enables execution of larger quantum algorithms on existing QPUs.

In an embodiment, the method includes receiving an input quantum circuit; dividing the input quantum circuit into a set of blocks, wherein the set of blocks includes an initial block and one or more additional blocks wherein the one or more additional blocks are consecutive and contiguous to the initial block, wherein the set of blocks comprises a series of gates; executing, by a Quantum Processing Unit, the set of blocks, wherein the initial block is executed on a first state and a block of the one or more additional blocks is executed in a second state wherein the initial block is executed on the first state and block of the one or more additional blocks is executed on a second state, wherein the Quantum Processing Unit executes each of the additional blocks in consecutive states until an end of the input quantum circuit; training, by the Quantum Processing Unit, a parametrized quantum circuit such that the parametrized quantum circuit is operable to reproduce the second state, wherein the second state is a quantum state that encodes results of all the quantum operations from the initial state until the operations of the block of the one or more additional block at the second state; and outputting, by the Quantum Processing Unit, an expected output of the input quantum circuit. The method where the additional block receives inputs only from the initial block. The method where each block of the set of blocks receives inputs of an approximate quantum state from a set of preceding blocks. The method where the approximate quantum state is approximated using any one of a parameterized quantum circuit, a Tensor Network, a Neural Network Quantum State, or other data structures that can be decomposed into a quantum circuit. The method where dividing the input quantum circuit into a set of blocks comprises maximizing a size for each block in the set of blocks such that the set of blocks are executable on the Quantum Processing Unit having a noise property, wherein the noise property is any one of a single qubit error rate, a gate error rate, a crosstalk error, a readout error or a device dependent parameter. The method where the noise property is between 0 percent and 25 percent. The method where dividing the input quantum circuit into a set of blocks comprises selecting a size for each block in the set of blocks such that a variance of a fidelity is larger than a predetermined threshold, wherein the variance of the fidelity is obtained by varying one or many gate parameters in the block. The method where selecting a size for each block in the set of blocks comprises increasing the size of each block gradually in iterations until the size of each block reaches the selected block size during the execution of each block. The method where executing, by the Quantum Processing Unit, the set of blocks does not require classical simulation for all the qubits of the input circuit. The method may further include detecting an onset of a Barren Plateau, wherein the detection of the onset includes identifying any one of a lack of expressibility, noise impact, quantum entanglement impact, or an overparameterization. The method where response to identifying the lack of expressibility, a cloud computing environment or a quantum edge environment is further configured to adjust an Ansatz to increase the expressibility.

### BRIEF DESCRIPTION OF THE DRAWINGS

All of the figures depict preferred embodiments although other embodiments are contemplated, and the present disclosure is not limited to the embodiments shown.

FIG. 1 is an example of a system for performing block-sequential circuit execution according to embodiments of the present disclosure.

FIG. 2 is a flow chart depicting a block-sequential circuit execution on a QPU according to embodiments of the present disclosure.

FIG. 3 is a diagrammatical overview of a process for splitting an input quantum circuit into optimally sized blocks having multiple elementary gates for block-sequential execution according to embodiments of the present disclosure.

FIG. 4 is another diagrammatical overview of an alternative process for splitting an input quantum circuit into optimally sized blocks having multiple elementary gates for block-sequential execution according to embodiments of the present disclosure.

FIG. 5 is a flow chart depicting an example of increasing a block size during a single iteration of the block-sequential execution according to embodiments of the present disclosure.

FIG. 6 is a flow chart depicting a process for detecting and characterizing a Barren Plateau during quantum circuit training according to embodiments of the present disclosure.

FIG. 7 depicts a set of results according to embodiments of the present disclosure.

### DETAILED DESCRIPTION

Advantages and features of the present disclosure and a method of achieving the same will be clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the disclosure to those of ordinary skill in the art to which the present disclosure pertains. The present disclosure is defined only by the scope of the claims. Throughout the present specification, like numbers refer to like elements.

As described briefly above, the reliability and accuracy of an output of an algorithm decreases as the number of algorithmic steps executed on a realistic noisy QPU grows. The noisy QPU refers to a quantum processor that operates in a computing environment where various real-world factors disturb states of qubits, which may lead to computational errors. The disturbances are caused because each quantum gate (e.g., a logical operation) intrinsically introduces complex errors which may entirely spoil the computations depending on how many quantum gates are included in the sequence. Thus, a solution as disclosed herein that effectively reduces the number of quantum gates in the quantum circuit embodying the algorithm being executed on the QPU is desirable.

Existing approaches to reducing the number of gates in the circuit representing a quantum algorithm on a given QPU architecture include a variety of different options. Some of the existing methods include rewriting the quantum circuit exactly prior to any execution. This approach includes logical rewriting methods that use mathematical gate identities to transform small local sub-pieces of the quantum circuit. The logical rewriting exactly reconstructs the original unitary of the algorithm via a shorter sequence of gates that are equivalent to the quantum circuit. Such methods can also utilize the information about the QPU topology (e.g. qubit connectivity). These methods form the core of the quantum compilation stack, mapping the abstract quantum circuit to a hardware specific set of operations and the QPU qubit layout. However, because these methods reconstruct the quantum circuit exactly, the optimizations available are very constrained and only allow modest reductions in circuit depth.

In some other approaches, synthesis-based compilation methods may be used. Synthesis-based compilation relies on the execution of portions up to and possibly including the entire quantum circuit on a classical simulator. A number of synthesis techniques rely on approximating small blocks of the original circuit by a unitary operator, which can be composed into a shorter sequence of gates using a classical (e.g., a non-quantum computing) simulator. The full approximate algorithm circuit is then reassembled by combining such blocks. This approximate circuit still needs to be executed on a simulator or a QPU. Because these methods rely on classical simulators, they can only optimize small quantum circuit blocks and the resulting reassembled quantum circuit is still too complex to accurately execute on a noisy quantum device.

Another approach includes approximating the entire circuit in a single step, using a shorter sequence of gates whose parameters are obtained executing the input circuit on a QPU. This approximate compilation method is directly executed on a quantum device and does not rely on a classical simulator. However, this method is strongly limited by the necessity to run the input circuit completely on a noisy QPU, which is prone to errors. The execution of the long (but not too long) original circuit provides sufficiently accurate cues to optimize a shorter approximant circuit but does not allow to sufficiently accurately evaluate the outputs of the quantum algorithm directly. Overall, the above methods provide limited improvement as the optimized circuit is typically still too deep to execute in full on a QPU without incurring debilitating errors.

An alternative approach involves execution of the quantum algorithms in parts. Unlike in classical computing, a naive generic division of the quantum circuit, separate execution of the parts, and their reassembly requires resources exponential in the number of connections between the parts, negating any potential advantage in practice. Step-by-step time evolution using iterative synthesis on a classical computer is also possible. The quantum circuit implementing the time evolution of physical quantum system (e.g., spin chains studied in condensed matter physics) can be obtained by the stepwise application of the evolution, where each step changes the state of the whole set of qubits only slightly. Using this observation, step-by-step methods of approximating such evolution circuits have been attempted. These methods sequentially approximate the state of the system after the next short evolution step ((gates belonging to a single Trotter Hamiltonian evolution step) by using the short circuit and approximating the evolution up to the previous block, compounding it with the next block and learning a new approximant of both blocks together. This process is repeated for all subsequent blocks. The resulting parametrized circuit is reproducing the state of a system at a particular time. As proposed, this method applies to simulations of quantum dynamics only. Additionally, in practical settings the error accumulated with each gate optimization quickly diverges with the number of gates, especially on a noisy QPU hardware.

As explained above, this disclosure improves quantum computer functionality by introducing a scalable block-sequential approximate quantum circuit execution method utilizing blocks of varying sizes, and a procedure to find optimal such sizes. This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

This disclosure is now described more fully with reference to various figures that are referenced above, in which some embodiments of this disclosure are shown. Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms (e.g., two, three, four) as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

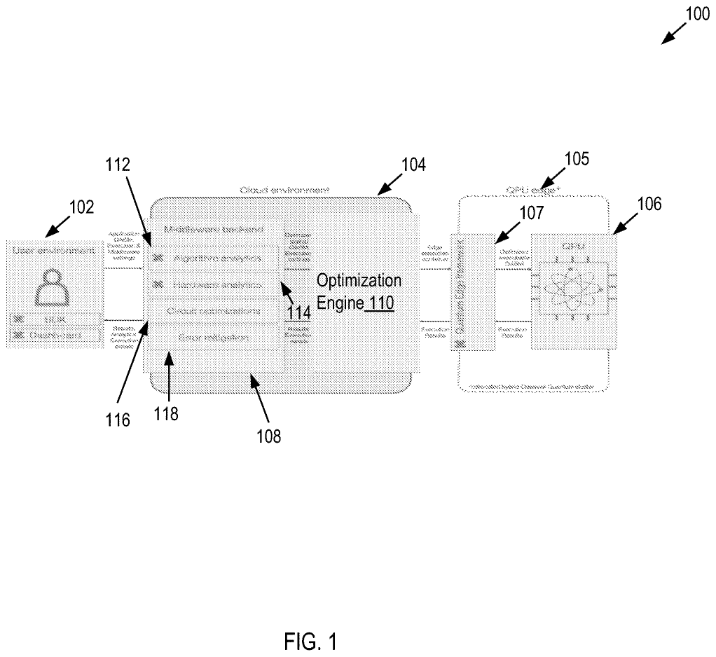

Turning now to the Figures, FIG. 1 is an example of a system for performing block-sequential circuit execution according to embodiments of the present disclosure. In particular, the system 100 includes a user environment 102, a cloud computing environment 104, and a QPU edge environment 105. The cloud computing environment 104 may include middleware backend 108 and optimization engine 110. The QPU edge environment 105 may include a QPU 106 and a quantum edge framework 107. While the user environment 102, the cloud computing environment 104, and the QPU edge environment 105 are illustrated as separate, this configuration is for explanatory purposes and these components can be partially or fully incorporated into each other. For example, the QPU 106 may be deployed into the cloud computing environment 104. In some embodiments, the user environment 102 may be accessible via the cloud computing environment 104.

The user environment 102 may be a program application executing on a user device such as a desktop, laptop, mobile computing devices. The user environment 102 may be accessible via a web browser or another type of interactive application. The user environment 102 enables an end-user to design or develop quantum algorithms. In some embodiments, the user environment 102 may include a software development kit (SDK) that enables the user to design algorithms using a quantum programming language such as Python or another programming language with quantum capabilities. The SDK may provide libraries or frameworks with pre-built algorithms or individual quantum operations. For example, the SDK may enable the user to build an algorithm using the pre-built algorithms, or individual quantum operations as components to the algorithm. The user environment 102 may also include a dashboard for collection and display of metrics relating to the execution of the quantum algorithms.

In an example, the user environment 102 is a program application configured to receive a series of quantum operations in a user-defined algorithm. In one example, the program application is a python or other programming language environment with necessary packages allowing to transform user-defined algorithm into series of quantum operations. In some embodiments, the user environment 102 may be a low-code/no-code environment that uses user instructions or interactions to generate a series of quantum operations. The user environment 102 translates the user-defined algorithm into a digital file format that is executable by the QPU by e.g., generating a Quantum Assembly Language (QASM) file. The user environment 102 communicates the QASM file to the cloud computing environment 104. In other examples, other intermediate representations that describe the quantum circuit using quantum gates, qubit allocations, or measurement operations are possible.

As described above, the cloud computing environment 104 includes the middleware backend 108. The middleware backend 108 may be an intermediate computing layer that interfaces between the user environment 102 and the QPU 106. The middleware backend 108 may be configured to perform a set of tasks such as analytics of the algorithm or corresponding quantum gates (e.g., circuit hardware), optimization, and error mitigation. The middleware backend 108 enhances the accuracy and efficiency of the quantum algorithm. To perform these functions, the middleware backend 108 may include a set of computing engines that are configured to perform subtasks. As illustrated in FIG. 1, the middleware backend 108 includes algorithm analytics engine 112, hardware analytics engine 114, circuit optimization engine 116, and error mitigation engine 118.

The algorithm analytics engine 112 may be a program application executing in the cloud computing environment 104 to evaluate and optimize the performance of the quantum algorithm received from the user environment 102 as described above. The algorithm analytics engine 112 analyzes factors such as a number of qubits used, the depth and structure of the circuit (e.g., number of quantum gate layers), and/or a fidelity of the algorithm. To perform the analysis, the algorithm analytics engine 112 computes an efficiency of the sequence of quantum gates and perform statistical analysis to generate a set of probabilistic results using typical quantum measurements. In an alternative or additional configuration, analytics may also be collected without running the quantum algorithm. For example, the algorithm analytics engine 112 may also compute and statistically analyze the efficiency of the gate sequence using quantum execution and measurements either on a simulated (classical) or QPU 106. In some embodiments, the analytics may be based on the properties of the graph of the quantum algorithm input to a machine learning predictive model.

The hardware analytics engine 114 may be a program application executing in the cloud computing environment 104 to evaluate and optimize the performance of the QPU 106 with reference to the algorithm received from the user environment 102. For example, the hardware analytics engine 114 identifies any hardware limitations of QPU 106 that may impact the execution of the algorithm such as qubit coherence times, fidelity of quantum gates, and expected error rates of the QPU 106. In some embodiments, the hardware analytics engine 114 may use external classical data about the hardware such as e.g., vendor-provided error map, or, alternatively, run additional diagnostic quantum circuits on the QPU 106 to perform extended analysis and optimization.

The circuit optimizations engine 116 may be a program application executed in the cloud computing environment 104 to reduce complexity of the quantum algorithm (e.g., the input circuit) without altering the function of the quantum algorithm. The circuit optimizations engine 116 may reduce the number of quantum gates required to perform the function of the quantum algorithm by identifying and eliminating redundant sequences of gates using exact gate identities or by combining consecutive quantum gates into streamlined equivalent gates. Additionally, the circuits optimizations engine 116 may decrease the depth of the quantum algorithm by using approximate, rather than exact, rewriting of the circuit or its subparts, using either classical or quantum computer. The circuit optimizations engine 116 may map logical cubits from the quantum algorithm to physical qubit positions within the QPU. By performing the mapping, the circuit optimizations engine 116 may reduce the need for swap gates in the algorithm. The circuit optimizations engine 116 may further include any other standard parts of the compilation/transpilation quantum software stack.

The error mitigation engine 118 may be a program application executing in the cloud computing environment 104 to reduce the impact of errors on the execution of the quantum algorithm during the circuit execution or in postprocessing of the measurement results. For example, the error mitigation engine 118 may be detecting and correcting certain qubit errors or adjusting the quantum algorithm based on the particular noise parameters of the QPU 106 or executing a whole set of modified quantum circuits and analyzing the results. By adjusting the quantum algorithm to the specific QPU 106, the error mitigation engine 118 may tailor the input circuit, its execution and result postprocessing to the hardware configuration of QPU 106.

The optimization engine 110 may be a program application executing in the cloud computing environment 104 to prepare and manage the optimal execution strategy to execute quantum algorithm operations on the QPU 106, and to post-process the results of the execution. For example, the optimization engine 110 may execute the operations of the algorithm in a block-sequential manner on the QPU 106 according to selected execution strategy (as described by process 200), and the results of the execution on QPU 106 are post processed according to the execution strategy. The final results of such optimized execution are of higher fidelity than direct execution on a QPU 106. In some embodiments, the optimization engine 110 may perform error correction, validation of QPU outputs, or other optimizations. The optimization engine 110 may output results or additional details of executing the blocks to the middleware backend 108 or to the user environment 102.

The QPU 106 may be a specialized processor designed to execute quantum computing operations. The QPU 106 performs operations on qubits which may exist in a state of superposition. The QPU is a part of QPU Edge environment. This is a Collocated Hybrid Classical-Quantum environment where classical and quantum computers are closely located to reduce network latency. This allows to run control, characterization, optimization, scheduling routines in the QPU Edge Environment 107. The state of superposition occurs when a qubit represents a combination of logical states “0” and “1” simultaneously. As the number of qubits grows the dimension of the Hilbert space in which computations happen increases exponentially, and in certain problems QPUs are expected to indeed provide an exponential advantage over classical computers. Quantum computing operations are performed using a sequence of quantum gates. The quantum gates manipulate the state of a qubit array by acting on individual qubits or groups of qubits and can increase or decrease entanglement between pairs or groups of qubits. The QPU may be further configured to measure the qubit. If the qubit is in a superposition state, the qubit will change state to one of the basis states when a measurement in a particular basis is performed. After performing the measurement, the QPU 106 can output a set of measurements represented as classical logical bit strings.

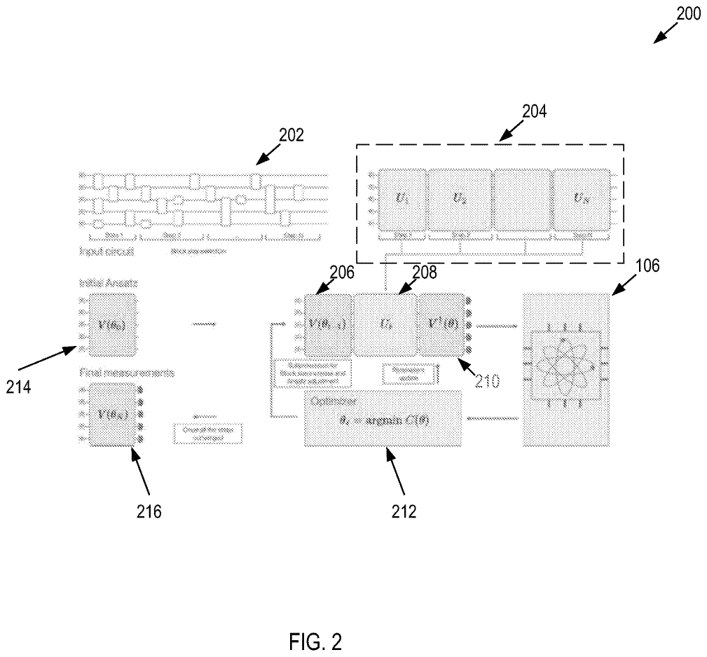

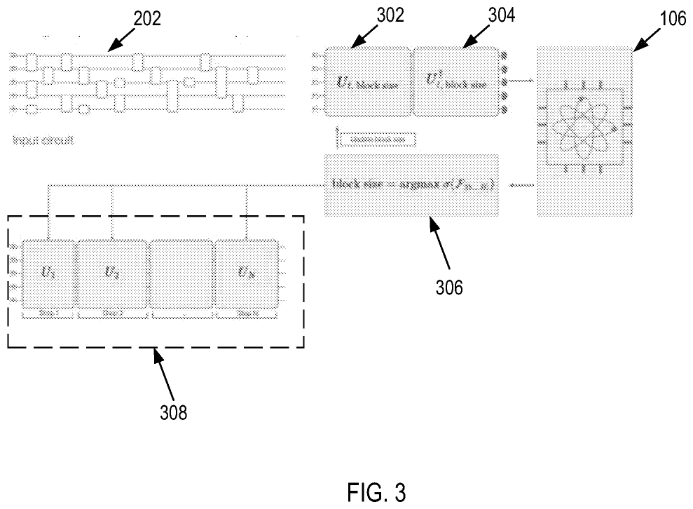

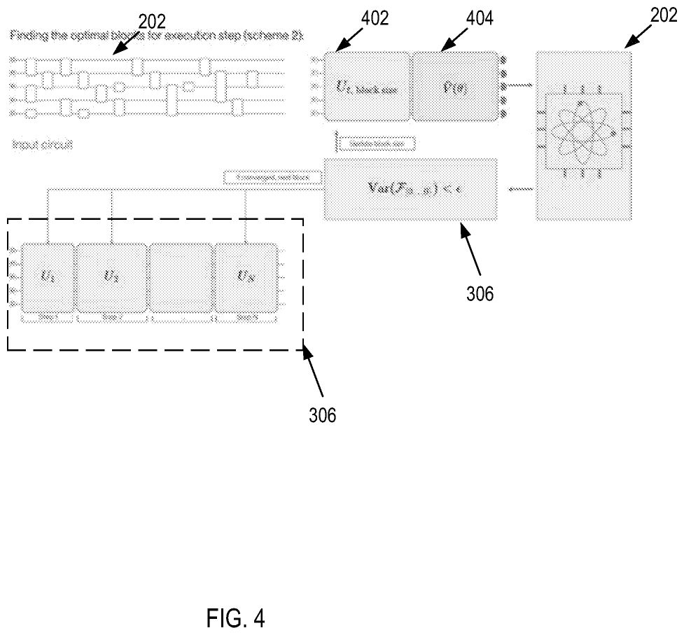

FIG. 2 is a flow chart depicting a block-sequential circuit execution process on a QPU according to embodiments of the present disclosure. The block sequential circuit execution process 200 is performed by the optimization engine 110 communicating with the QPU 106. The block-sequential circuit execution process 200 receives (from the middleware backend 108) the input circuit 202. The process 200 then divides the input circuit into separate sequential execution blocks 204, the possible implementations of which procedures are depicted by FIG. 3 or FIG. 4. The process 200 further executes the blocks 204 sequentially on the QPU 106, using a strategy utilizing auxiliary parameterized quantum circuits (PQC) 206 and 210, and further comprising steps 212-216. As illustrated in FIG. 2, the block-sequential circuit execution process 200 executes the blocks 204 sequentially on the QPU 106, using a strategy utilizing auxiliary parameterized quantum circuits denoted as 206 and 210, respectively. The V(θₜ₋₁) PQC 206 approximates the quantum state of the system after applying the blocks of the input circuit 202 up to and including the preceding block Uₜ₋₁ to the initial state of the quantum register. The parameters of V(θₜ) PQC 210 are adjusted in step “t” using procedure 212, which also employs the QPU 106, so that V(θₜ) 210 approximates the state of the system after parameterized quantum circuit V(θₜ₋₁) 206 followed by the current block Uₜ 208 have been executed. In the following step “t+1”, the V(θₜ) 210 becomes 206, the block Uₜ₊₁ becomes current block 208 and a fresh PQC 210 is trained. This is repeated until all the blocks Uᵢ of the input circuit 202 are executed. When described together, the current block 208, and the transposed complex conjugate of the next approximation 210 may be referred to as “stacked circuits 206-210.”

In an example the optimization engine 110 first divides a given input quantum circuit into a set of blocks 204. The set of blocks 204 includes a number “N” of consecutive and contiguous blocks such that the set of blocks 204 may be represented by U=Uₙ Uₙ₋₁ . . . U, where U represents the target unitary operator provided in the input 202. The individual blocks Uᵢ are sequentially executed in the procedure in steps 206-216, the currently executed block Uᵢ being denoted as 208. In the subsequent step of the procedure the following block Uᵢ₊₁ assumes the role of 208. As used herein, the “target unitary operator” refers to a specific unitary transformation embodying the quantum algorithm that is intended to be implemented in the QPU 106. As mentioned above, these transformations may be a composed action of elementary quantum logical operations leading to entangling of the qubits, individual qubit rotations, swapping of pairs of qubits and other. After having divided the input circuit 202 into blocks 204 using e.g., strategies described in FIGS. 3-4, the optimization engine 110 proceeds to execute them one-by-one, i.e., sequentially. In each of the steps the stacked circuits 206-210 are updated and executed on the QPU 106, so that at the end of the step the PQC 210 represents the state of the system after executing the blocks of 204 until this step. In the very first step of the procedure the initial ansatz 214 is used. In some embodiments, the QPU 106 iteratively executes the stacked set of circuits 206-210, the optimization engine 110 performs iterative execution of blocks 206-210 on the QPU 106 up until ansatz 210 represents the final state of the quantum algorithm 216, and the output measurements may be performed on the QPU 106.

During this iterative execution, each block contains all the qubits and receives inputs only from the immediately preceding block. The stacked set of circuits 206-210 are executed sequentially in steps on the QPU 106, starting from the initial block whose input is the algorithm's initial state (e.g., state of all qubits initialized to the all-0 state in the computational basis). The algorithm's initial state may be any state, which in some examples is the all-0 state that may be represented by |0 . . . 0 [symbol] . For each subsequent iteration of the procedure, the optimization engine 110 trains a PQC V(O) to represent the quantum state obtained by applying the block Uₜ in step “t” to the state created by executing the circuit up to the preceding step t−1 which is represented by the previous PQC V(θₜ₋₁) The parametrized quantum circuit is sufficiently shallow to be trained and executed accurately on a noisy QPU.

To generate an approximation of the state at step “t”, evolved by all the algorithm gates up to and including step “t−1” followed by the application of the block Uₜ, the optimization engine 110 uses an approximate variational compilation by constructing a variational circuit V(O) and determining a set of parameters θ* such that V(θₜ₋₁)Uₜ≈V(θ*). In some examples, the meaning of the approximate equality may differ. In a first meaning the approximate equality, the operators agree on a single state, which may be the state |0). This can be done by maximizing the overlap given by [symbol] 0|V(θₜ₋₁)UₜV^{†}(θ)|0>. A second meaning of the approximate equality is that the operators agree on the full Hilbert space, equivalent to maximizing the average quantum fidelity between U and V(θ). In practice, this can be implemented via the Hilbert-Schmidt test.

The variational optimization of the parameters θ necessarily entails some error, even on an ideal device. These errors are compounded when the compilation procedure is iterated. As used herein “iterative” or “sequential” describes a procedure in which having learned an approximation Vₖ₋₁ of the action of the first k−1 slices of the operator U so that

$$V ( {θ}_{k - 1}^{*} ) \approx {U}_{k - 1} … {U}_{1} ,$$

the action of the k-th slice can be absorbed by minimizing [symbol] 0|V(θ*ₖ₋₁)UₖV^{†}(θₖ)|0 [symbol] with respect to the parameters θₖ (with

$${θ}_{k - 1}^{*} ,$$

which was learned in a previous step). In this fashion, execution of the full deep circuit U may not be necessary but rather only the shallow slices Uᵢ. Note that in step k, the slice Uₖ is applied to the already approximate

$$V ( {θ}_{k - 1}^{*} ) .$$

Furthermore, when performing the procedure on a noisy device, either hardware or simulated one, the operators Uᵢ are also not implemented precisely, but rather their noisy versions Nᵢ. For example, in the first step,

$${θ}_{1}^{*} = arg max ( 〈 0 \vert {V}_{1}^{†} ( θ ) {N}_{1} \vert 0 〉 ,$$

with U₁−N₁:=E₁, where |E₁|:=ε₁ is the error already incurred by imperfectly implementing the circuit block U₁ on a realistic noisy device. Similarly, V₁−N₁:=Δ₁, where |Δ₁|:=δ₁, is the difference between the trained Ansatz (e.g., an initial value of the quantum state)

$${V}_{1} = V ( {θ}_{1}^{*} )$$

and the noisy version N₁. The purpose of the block splitting procedures described in FIGS. 3,4 is to adaptively provide a splitting of the input circuit 202 minimizing the total incurred errors during the sequential execution.

While the QPU 106 and the optimization engine 110 iterate through this procedure, the optimization engine 110 monitors the qubits for convergence of the steps. The optimization engine 110 determines if the overlap measurements for the final algorithm block successfully converged, and prepares the final measurements 216 based on resulting variational circuit V(θₙ). The set of final measurements 216 may include a set of classical logic bits. As described above, while making a final measurement, the qubit being measured will collapse from a superposition state to a base state of “0” or “1” that can be output. As one of skill in the art will appreciate, the probabilistic nature of quantum mechanics may generate different sets of final measurements 216 even for an identical quantum operation that is repeated an additional time (e.g., two identical input circuits can produce different sets of final measurements).

FIG. 3 is a diagrammatical overview of a process for splitting an input quantum circuit into blocks having multiple elementary gates for block-sequential execution according to embodiments of the present disclosure. In particular, FIG. 3 depicts dividing the input circuit 202 into a set of blocks, where the optimal size of the current block, denoted by 302, is determined by examining the dependence of the standard deviation of the fidelity of executing 302 and its hermitian conjugate 304 on the size of the block 302. In some embodiments, the gate sequence representing the operator block 304 may be different from simply inverting the gate sequence for the block 302. The block division procedure of the optimization engine 110 executes the stacked blocks 302 and 304 on the QPU 106. The optimization engine 110 receives the output of the QPU 106 and determines if an adjustment to the block is needed. If the optimization engine 110 determines that the block size can be increased, an updated block size may be computed. The optimization engine 110 may update the size of block 302 and/or block 304. If the optimization engine 110 determines that the block size cannot be increased, then this block size is used for the block Uₜ at step t and procedure continues for the next block. As iterations reach the end of input algorithm QASM file, the procedure finishes and results in an adaptive block sequence 308. As illustrated by FIG. 3, U₂ is larger than U₁ which emphasizes the ability for the input circuit 202 to be split into adaptively sized blocks.

In an example, to optimize the block-sequential execution process, the optimization engine 110 may maximize the block size of Uₜ for which the auxiliary PQC V(θₜ) is still accurately trainable. By maximizing the block size, the number of steps N of the block-sequential execution process (e.g., as illustrated by FIG. 2) may be reduced. With the reduction in the number of steps N, the block-sequential execution process may be executed more accurately on a noisy QPU due to a smaller number of circuits V(θₜ) which need to be trained. One of possible ways in which the optimization engine 110 may maximize the block size is by measuring the standard deviation of the fidelity of a mirrored circuit

$${U}_{t} {U}_{t}^{†} .$$

The optimization engine 110 selects the block size for which a maximum of the standard deviation is achieved. In practice, the standard deviation has a non-trivial maximum: the standard deviation is small for very short circuits (i.e., very short circuits achieve almost perfect fidelity) and also for very long circuits (very long circuits have fidelity that is effectively zero), with the maximum achieved for circuits of intermediate length.

FIG. 4 is another diagrammatical overview of another process for splitting an input quantum circuit into blocks having multiple elementary gates for block-sequential execution according to embodiments of the present disclosure. More specifically, FIG. 4 depicts the process of splitting the input circuit 202 into blocks using a randomly parametrized circuit \tilde{V}(θ), instead of the mirroring procedure described above. The optimization engine 110 stacks a target unitary operator block 402 with a variable block 404 that contains the randomly parametrized circuit.

For a selected block size, the optimization engine 110 stacks a circuit block with a random parametrized circuit \tilde{V}(θₜ). The Barren Plateau is a regime in which it is impossible to train the parameters of a variational quantum circuit. The optimization engine 110 selects the largest block size for which the variance of the fidelity is still larger than a predetermined threshold value F. As the value of the variance decreases below the predetermined threshold value F, the previous block size is selected.

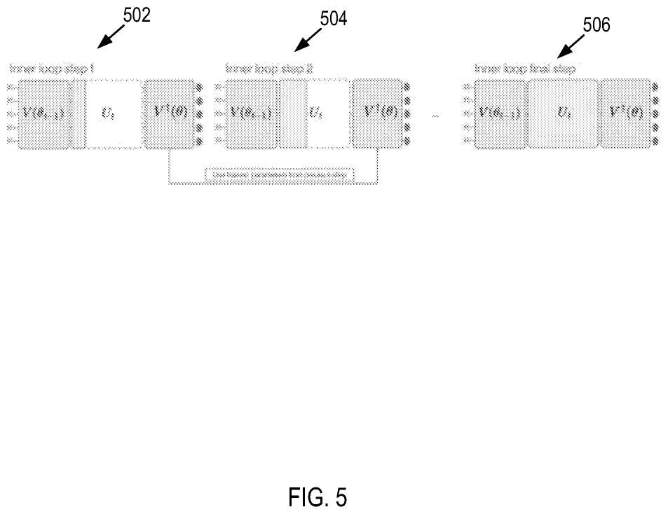

FIG. 5 is a flow chart depicting an example of increasing a block size during a single iteration of the block-sequential execution process according to embodiments of the present disclosure. For large blocks during a specific iteration (e.g., at step t), the trained unitary V(θₜ) may be very distant (in e.g., trace distance or other norm distance) from the trained unitary V(θₜ₋₁) of the preceding step (e.g., a step t−1). The distance between the trained unitaries may make training of the parametrized circuit V(θₜ) difficult. The optimization engine 110 may resolve this difficulty by gradually increasing the size of the blocks for each iteration, the size of subpart of the block Uₜ being learned during each iteration i of the inner training loop. As illustrated by FIG. 5, a first step 502, a second step 504, and a third step 506 of increasing size are depicted. During each step i of the inner training loop (executed for every step t of the block sequential execution procedure depicted in FIG. 2), the optimization engine 110 trains the parametrized circuit V(θ_{t,i}) using the mirror or another equivalent method (e.g., as described with reference to FIG. 2). The optimization engine 110 uses the trained parameters of V(θ_{t,i}) to initialize the parameters of V(θ_{t,i+i}) during the subsequent step i+1. In this way the quantum circuit V(θ_{t,i}) evolves towards V(θ_{t,final}), with each subsequent step requiring only a small change of the parameters of the quantum circuit, improving the overall trainability. The change in size of the subpart of Uₜ being learned from the first step 502 to the second step 504 and from the second step 504 to the third step 506 illustrates the increase in block size until the V(θ_{t,i}) is trained.

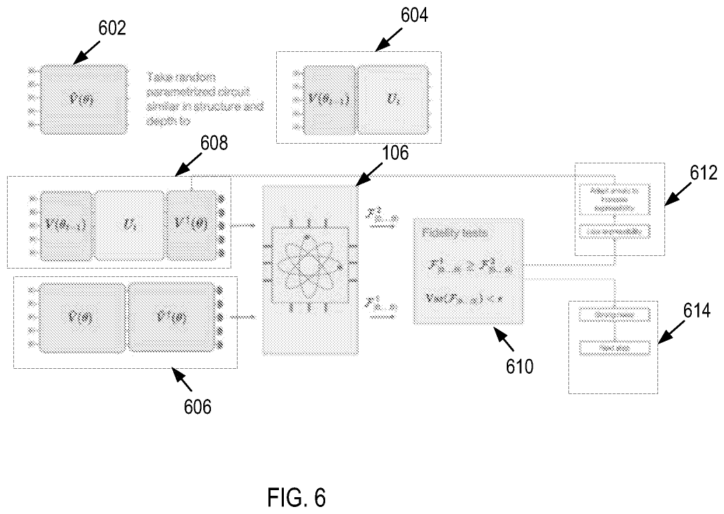

FIG. 6 is a flow chart 600 depicting a process for detecting and characterizing a Barren Plateau during quantum circuit training according to embodiments of the present disclosure. During the training of a parametrized quantum circuit (anytime such circuits are used, such as in block-sequential execution in FIG. 2), some qualitatively different phenomena may obstruct a convergence to the minimum of an optimization objective (e.g., fidelity).

For example, some obstructions may be caused by an insufficient expressivity of the Ansatz to capture a solution, or by an occurrence of a Barren Plateau (BP), when the circuit becomes effectively untrainable due to the exponential concentration of the cost function. The sources and possible remedies of BPs are different. Accordingly, detection of the onset and type of the BP is crucial during training. A first type of BP is a “noise-induced BP” caused by noise in the quantum device effectively smearing the result of the execution of any sufficiently deep quantum circuit. A second type of BP is an “entanglement-induced BP” that occurs when the variational quantum circuit is too expressive. Counterintuitively, if a circuit is able to in principle generate every possible state, in practice finding parameters for any particular state is difficult.

To distinguish in training between the types of BPs from the more trivial lack of circuit expressivity, the optimization engine 110 is configured to perform the process for detecting and characterizing a Barren Plateau during quantum circuit training illustrated in FIG. 6. This process is described with the example of block-sequential training, but the approach is also applicable more broadly in any scenario of learning a quantum state. For example, when, given a current parametrized Ansatz V(θₜ) at a step t, the process of training slows down because the fidelity of V(θₜ₋₁)UₜV^{†}(θₜ) 608 of the stacked circuit VUV denoted by 608 plateaus at non-zero value. The optimization engine 110, in step 610, compares the fidelity of V(θₜ₋₁)UₜV^{†}(θₜ) 608 and a corresponding variance to the fidelity of a mirrored auxiliary circuit 606 \tilde{V}(θₜ)\tilde{V}^{†}(θₜ). For an ideal device the fidelity of the mirrored auxiliary circuit 606 should be equal to 1, and the deviation from that value provides an indication of noise level in the device. The circuit 602 \tilde{V}(θₜ) is a parametrized circuit having a quantum gate structure and depth (topology) that mimics the circuit 604 V(θₜ₋₁)Uₜ that V(θₜ) is intended to reproduce. In a case where the the auxiliary fidelity vanishes, the optimization engine 110 determines that the circuit V(θₜ₋₁)Uₜ is too long for the noise level on the QPU 106. In response to determining that the circuit V(θₜ₋₁)Uₜ is too long, the QPU 106 reduces the block size of Uₜ at step 614. Alternatively, if auxiliary fidelity is higher than for V(θₜ₋₁)UₜV^{†}(θₜ), the middleware backend 108 may increase the expressibility of V(θₜ) by adding additional layers or quantum gates at block 612.

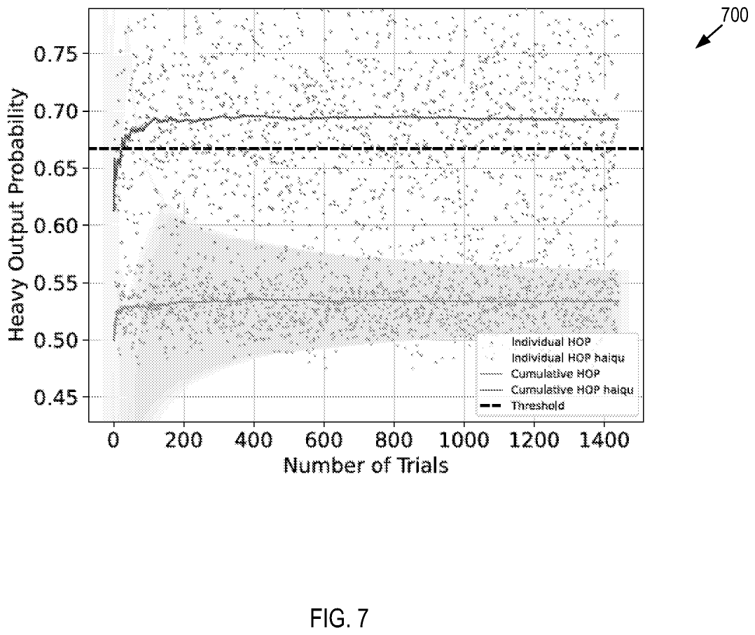

FIG. 7 depicts a set of results in a chart according to embodiments of the present disclosure. The chart 700 depicts performance of the system and method as disclosed herein on the example of execution of Quantum Volume circuits and calculation of corresponding Heavy Output Probability (HOP) on a simulated noisy QPU. The results in chart 700 demonstrate that the optimised execution 110 utilising the block-sequential procedure depicted in FIG. 2 allows to increase the quantum volume of the QPU, as indicated by the HOP crossing above the ⅔ threshold (as per standard definition of quantum volume measurements). This is indicated as “Cumulative Hop Haiqu” in contrast to “Cumulative Hop” computed by running Quantum Volume circuits without employing the methods describes in the present disclosure, which fails to clear the threshold.

This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Similarly, as used herein, various singular forms “a,” “an” and “the” are intended to include various plural forms as well, unless context clearly indicates otherwise. For example, a term “a” or “an” shall mean “one or more,” even though a phrase “one or more” is also used herein.

Moreover, terms “comprises,” “includes” or “comprising,” “including” when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

Additionally, although terms first, second, and others can be used herein to describe various elements, components, regions, layers, or sections, these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section without departing from this disclosure.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled artisans know that various modifications, additions, substitutions, and the like can be made without departing from spirit of this disclosure. As such, these are considered to be within the scope of the disclosure, as defined in the following claims.

1. A method comprising:
receiving an input quantum circuit;
dividing the input quantum circuit into a set of blocks, wherein the set of blocks includes an initial block and one or more additional blocks, wherein the one or more additional blocks are consecutive and contiguous to the initial block, wherein the set of blocks comprises a series of gates;
executing, by a Quantum Processing Unit, the set of blocks, wherein the initial block is executed on a first state and a block of the one or more additional blocks is executed in a second state wherein the initial block is executed on the first state and block of the one or more additional blocks is executed on a second state, wherein the Quantum Processing Unit executes each of the additional blocks in consecutive states until an end of the input quantum circuit;
training, by the Quantum Processing Unit, a parametrized quantum circuit such that the parametrized quantum circuit is operable to reproduce the second state, wherein the second state is a quantum state that encodes results of all the quantum operations from the initial state until the operations of the block of the one or more additional block at the second state; and
outputting, by the Quantum Processing Unit, an expected output of the input quantum circuit.

2. The method of claim 1, wherein the additional block receives inputs only from the initial block.

3. The method of claim 1, wherein each block of the set of blocks receives inputs of an approximate quantum state from a set of preceding blocks.

4. The method of claim 3, wherein the approximate quantum state is approximated using any one of a parameterized quantum circuit, a Tensor Network, a Neural Network Quantum State, or other data structures that can be decomposed into a quantum circuit.

5. The method of claim 1, wherein dividing the input quantum circuit into a set of blocks comprises maximizing a size for each block in the set of blocks such that the set of blocks are executable on the Quantum Processing Unit having a noise property, wherein the noise property is any one of a single qubit error rate, a gate error rate, a crosstalk error, a readout error or a device dependent parameter.

6. The method of claim 5, wherein the noise property is between 0 percent and 25 percent.

7. The method of claim 1, wherein dividing the input quantum circuit into a set of blocks comprises selecting a size for each block in the set of blocks such that a variance of a fidelity is larger than a predetermined threshold, wherein the variance of the fidelity is obtained by varying one or many gate parameters in the block.

8. The method of claim 7, wherein selecting a size for each block in the set of blocks comprises increasing the size of each block gradually in iterations until the size of each block reaches the selected block size during the execution of each block.

9. The method of claim 1, wherein executing, by the Quantum Processing Unit, the set of blocks does not require classical simulation for all the qubits of the input circuit.

10. The method of claim 1 further comprising detecting an onset of a Barren Plateau, wherein the detection of the onset includes identifying any one of a lack of expressibility, noise impact, quantum entanglement impact, or an overparameterization.

11. The method of claim 10, wherein in response to identifying the lack of expressibility, a cloud computing environment or a quantum edge environment is further configured to adjust an Ansatz to increase the expressibility.

12. A system comprising:
a cloud computing environment configured to:
receive an input quantum circuit;
divide the input quantum circuit into a set of blocks, wherein the set of blocks includes an initial block and one or more additional blocks, wherein the one or more additional blocks are consecutive and contiguous to the initial block, wherein the set of blocks comprises a series of gates; and
a quantum processing unit configured to:
execute the set of blocks, wherein the initial block is executed on a first state and a block of the one or more additional blocks is executed in a second state wherein the initial block is executed on the first state and block of the one or more additional blocks is executed on a second state, wherein the Quantum Processing Unit executes each of the additional blocks in consecutive states until an end of the input quantum circuit;
train a parametrized quantum circuit such that the parametrized quantum circuit is operable to reproduce the second state, wherein the second state is a quantum state that encodes results of all the quantum operations from the initial state until the operations of the block of the one or more additional block at the second state; and
output an expected output of the input quantum circuit.

13. The system of claim 12, wherein the additional block receives inputs only from the initial block.

14. The system of claim 12, wherein each block of the set of blocks receives inputs of an approximate quantum state from a set of preceding blocks.

15. The system of claim 12, wherein to divide the input quantum circuit into a set of blocks, the cloud computing environment is further configured to maximize a size for each block in the set of blocks such that the set of blocks are executable on the Quantum Processing Unit having a noise property, wherein the noise property is any one of a single qubit error rate, a gate error rate, a crosstalk error, a readout error or a device dependent parameter.

16. The system of claim 12, wherein to divide the input quantum circuit into a set of blocks, the cloud computing environment is further configured select a size for each block in the set of blocks such that a variance of a fidelity is larger than a predetermined threshold.

17. The system of claim 16, wherein selecting a size for each block in the set of blocks comprises increasing the size of each block gradually in iterations until the size of each block reaches the selected block size during the execution of each block.

18. The system of claim 12, wherein executing, by the Quantum Processing Unit, the set of blocks does not require classical simulation for all the qubits of the input circuit.

19. The system of claim 12, the cloud computing environment is further configured to detect an onset of a Barren Plateau, wherein the detection of the onset includes identifying any one of a lack of expressibility, noise impact, quantum entanglement impact, or an overparameterization.
